(19) United States
(12) Patent Application Publication
(10) Pub. No.: US 2009/0145338 A1
(43) Pub. Date: Jun. 11, 2009

(54) Portable rapid work station

(76) Inventors: Michael Harmik Panosian, Glendale, CA (US); Joshua Keeler, Glendale, CA (US); James Stobar, Glendale, CA (US)

Correspondence Address: Michael H. Panosian, 2425 Canada Blvd. (#102), Glendale, CA, 91208, US

(21) Appl. No.: 12/001,418

(22) Filed: Dec. 10, 2007

(51) Int. Cl. B25H 1/04

(52) U.S. Cl. 108/50.11

(57) ABSTRACT

A portable work station is convertible between a collapsed condition suitable for storage and transport and an expanded condition suitable for use as a work bench. The work station includes a central panel serving as a work table or bench positionable in generally horizontal plane when the work station is expanded. The central panel defines two opposing generally parallel ends. Legs at one of the parallel ends are movable between collapsed conditions within the collapsed work station and generally vertical positions when the work station is expanded for use as a work bench or table. A storage device is provided at the other end of the parallel ends movable between a collapsed condition substantially in parallel planes with the work table or bench and an extended condition substantially normal to the work table or bench. The storage device includes storage compartments or bins for storing tools, hardware or the like in the expanded condition of the work station. Rolling members on the storage device transport the work station in its collapsed condition by rolling it along a generally horizontal surface.

### BACKGROUND OF THE INVENTION

1. Field of the Invention

The invention generally relates to work stations and, more specifically, to a portable rapid workstation.

2. Description of the Prior Art

Work stations of all types have been proposed. Some are static or fixed and others can be assembled at a worksite. However, those workstations that must be assembled at a worksite must be transported to that worksite and assembled there. Such workstations are generally bulky and assembly can be tedious and cumbersome. When a person has completed using it such workstations need to be disassembled and transported back to a home-base or to another worksite. In some cases, where the workstation is large, bulky or heavy two or more people may be needed to transport and/or assemble the workstation.

### SUMMARY OF THE INVENTION

Accordingly, it is an object of the invention to provide a workstation that is easy to transport from one location to another.

It is another object of the invention to provide a workstation that requires no assembly at a worksite.

Still another object of the invention is to provide a workstation that collapses into a cart-like device that is easy to transport and store.

It is yet another object of the invention to provide a workstation of the type suggested above that incorporates storage areas for storing tools and/or materials needed at a work site.

It is a further object of the invention to provide a workstation of the type under discussion that provides professionals and do-it-yourselfers with a work surface area suitable for many smaller to medium-sized projects.

### BRIEF DESCRIPTION OF THE DRAWINGS

These and other objects of the present invention will become apparent when it is considered in detail in the below specification, taken with the drawings as follows:

FIG. 1 is a perspective rendering of a workstation in accordance with the invention, wherein the workstation is fully collapsed into a cart-like unit with wheels and a handle to facilitate rolling of the unit from one location to another

FIG. 2 is similar to FIG. 1, but showing the workstation a extended condition ready to be used at a worksite.

### DESCRIPTION OF THE PREFERRED EMBODIMENT

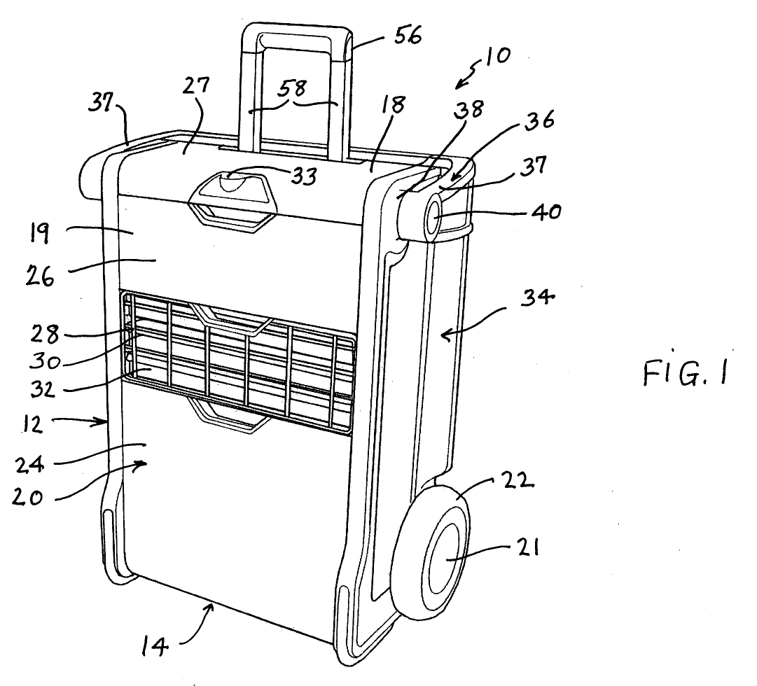

Referring now to the figures, in which identical or similar parts are designated by the same reference numerals throughout, and first referring to FIG. 1, the workstation in accordance with the present invention is generally designated by the reference numeral 10.

The workstation 10 is formed of a main body in the form of a housing 12 having a bottom or end the wall 14, opposing lateral end or sidewalls 16, a top wall 18 and a rear wall opposite a front wall 19. The aforementioned walls provide a substantially rectangular housing 20. Provided along the rear bottom edge of the housing 12 is an axle or shaft 21 which supports wheels 22.

The front wall 19 is formed of a lower panel 24 and an upper panel 26 both of which may be removably mounted on suitable pivots or otherwise to provide access to internal compartments in which tools or materials may be stored. In addition to the panels 24, 26 there is provided grill 28 which renders visible a plurality of shelves 30 on which a plurality of storage bins 32 are supported. The grill also serves to retain the bins 32 on the shelves 30 so that the bins remain organized and may not be removed unless the grill 28 itself is removed to expose all of the bins. It will be appreciated that the number of panels, the shapes and sizes of the storage compartments, the number of shelves 30 and the like are not critical and any layouts or configurations of the storage of tools and materials within the housing 28 may be used to accommodate specific work projects.

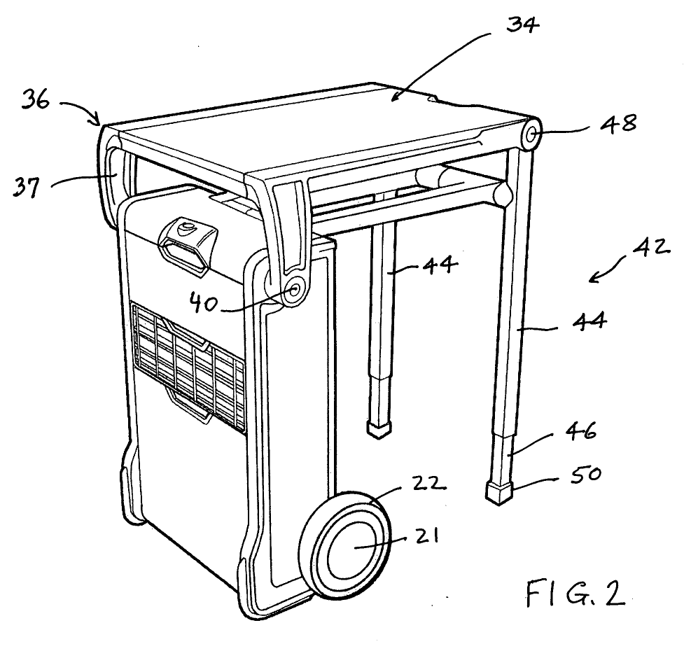

Mounted on the upper front corner or edge of the housing is a yoke 36 the free ends or arms 37 of which are positioned proximate to bosses 38 and rotatably mounted thereon by means of pivots 40. Referring to FIG. 2, the opposite ends of the yoke or arms 37 forming the yoke are secured to a table 34. At the remote end of the table 34 a pair of legs 42 are provided. Each of the legs are preferably adjustable to allow the remote end of the table 34 to be elevated or lowered to level it and render it substantially horizontal at a worksite even if the support surface is not entirely horizontal. This may be done by the use of two telescoping tubes 44, 46, the length of the legs being adjustable by inserting or withdrawing the inner tube 46 from the outer tube 44. Any know means for locking the telescoping tubes in fixed relative positions may be used. Rubber feet 50 or any other means may be used to prevent slipping or movements of the legs 42 on a surface on which the unit is placed and to protect that surface from possible damage due to movements of the legs during work on the table. Stabilizer bars 52, 54 may be used to fix the legs 42 relative to each other and to the housing 20.

A handle 56 may be mounted on slidably supported rods 58, similar to those commonly used on luggage and carts designed to be pulled and rolled on wheels.

It will be clear that the workstation 10 is fully assembled both when the unit is collapsed as well as when it is expanded for use. Thus, the workstation may be conveniently rolled to any location and simply opened to the position shown in FIG. 2. It is immediately ready for use, including the availability of the equivalent of a tool box in which small and large hand-tools as well as materials can be stored.

While the preferred embodiments have been shown and described, it will be understood that the there is no intention to limit the invention by such disclosure, but rather, it is the intention to cover all modifications and alternate constructions falling within the spirit and scope of the appended claims.

1. A portable work station convertible between a collapsed condition suitable for storage and transport and an expanded condition suitable for use as a work bench, the work station comprising a central panel serving as a work table or bench positionable in generally horizontal plane when the work station is expanded, said central panel defining two opposing generally parallel ends; leg means at one of said parallel ends and movable between collapsed conditions within said collapsed work station and generally vertical positions when the work station is expanded for use as a work bench or table; storage means provided at the other of said parallel ends movable between a collapsed condition substantially in parallel planes with said work table or bench and an extended condition substantially normal to said work table or bench, said storage means including storage compartments or bins for storing tools, hardware or the like in the expanded condition of the work station; and rolling means on said storage means for transporting the work station in its collapsed condition by rolling it along a generally horizontal surface.

2. A portable work station as defined in claim 1, further comprising gripping means for facilitating gripping of the work station in its collapsed condition for facilitating rolling of the work station along the horizontal surface.

3. A portable work station as defined in claim 1, wherein said leg means are formed of telescoping members for adjusting the lengths of said leg means for leveling said central panel for compensating for the heights of said storage means and variations in said horizontal surface.
